(19) United States
(12) Patent Application Publication
(10) Pub. No.: US 2009/0327974 A1
(43) Pub. Date: Dec. 31, 2009

(54) USER INTERFACE FOR GESTURAL CONTROL

(75) Inventors: Thamer A. Abanami, Seattle, WA (US); Julian Leonhard Selman, Redmond, WA (US); Craig E. Lichtenstein, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/147,463

(22) Filed: Jun. 26, 2008

(51) Int. Cl. G06F 3/033

(52) U.S. Cl. 715/863

(57) ABSTRACT

A UI (user interface) for gestural control enhances the navigation experience for the user by preventing multiple gestures from being inadvertently invoked at the same time. This problem is overcome by establishing two or more categories of gestures. For instance, the first category of gestures may include gestures that are likely to be invoked before gestures that are included in the second category of gestures. That is, gestures in the second category will typically be invoked after a gesture in the first category has already been invoked. One example of a gesture that falls into the first category may be a gesture that initiates operation of a device, whereas a gesture that falls into the second category may be change in volume. Gestures that fall into the second category require more criteria to be satisfied in order to be invoked than gestures that fall into the first category.

### BACKGROUND

A central attribute that determines a product's acceptability is usefulness, which measures whether the actual uses of a product can achieve the goals the designers intend them to achieve. The concept of usefulness breaks down further into utility and usability. Although these terms are related, they are not interchangeable. Utility refers to the ability of the product to perform a task or tasks. The more tasks the product is designed to perform, the more utility it has.

Consider typical Microsoft® MS-DOS® word processors from the late 1980s. Such programs provided a wide variety of powerful text editing and manipulation features, but required users to learn and remember dozens of arcane keystrokes to perform them. Applications like these can be said to have high utility (they provide users with the necessary functionality) but low usability (the users must expend a great deal of time and effort to learn and use them). By contrast, a well-designed, simple application like a calculator may be very easy to use but not offer much utility.

Both qualities are necessary for market acceptance, and both are part of the overall concept of usefulness. Obviously, if a device is highly usable but does not do anything of value, nobody will have much reason to use it. And users who are presented with a powerful device that is difficult to use will likely resist it or seek out alternatives.

The development of user interfaces (“UIs”) is one area in particular where product designers and manufacturers are expending significant resources. While many current UIs provide satisfactory results, additional utility and usability are desirable.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A UI (user interface) for gestural control enhances the navigation experience for the user by preventing multiple gestures from being inadvertently invoked at the same time. This problem is overcome by establishing two or more categories of gestures. For instance, the first category of gestures may include gestures that are likely to be invoked before gestures that are included in the second category of gestures. That is, gestures in the second category will typically be invoked after a gesture in the first category has already been invoked. One example of a gesture that falls into the first category may be a gesture that initiates operation of a device, whereas a gesture that falls into the second category may be change in volume. Gestures that fall into the second category require more criteria to be satisfied in order to be invoked than gestures that fall into the first category.

In one illustrative example, a scrub is used as a gesture that falls into the first category. The scrub is triggered by a single criterion, namely, that the touch input crosses one tick line on a touch pad. A gesture that falls into the second category may be a long scrub, which is triggered by the criterion needed to trigger a scrub, plus a second criterion, which may be that the touch input crosses a second tick line on the touch pad.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative environment including a portable media player in which the present user interface with physics engine for natural gestural control may be implemented;

FIG. 2 shows an exploded assembly view of an illustrative GPad;

FIG. 3 shows details of the touchpad in an isometric view of its back surface;

FIG. 4 shows an exploded assembly view of an illustrative touchpad;

FIG. 5 shows an input being received by the GPad;

FIG. 6 shows a moving input being received by the GPad;

FIG. 7 shows tick lines on the GPad.

FIG. 8 shows an illustrative arrangement in which a gesture engine receives gesture events;

FIG. 9 is a flowchart for an illustrative scrub event.

### DETAILED DESCRIPTION

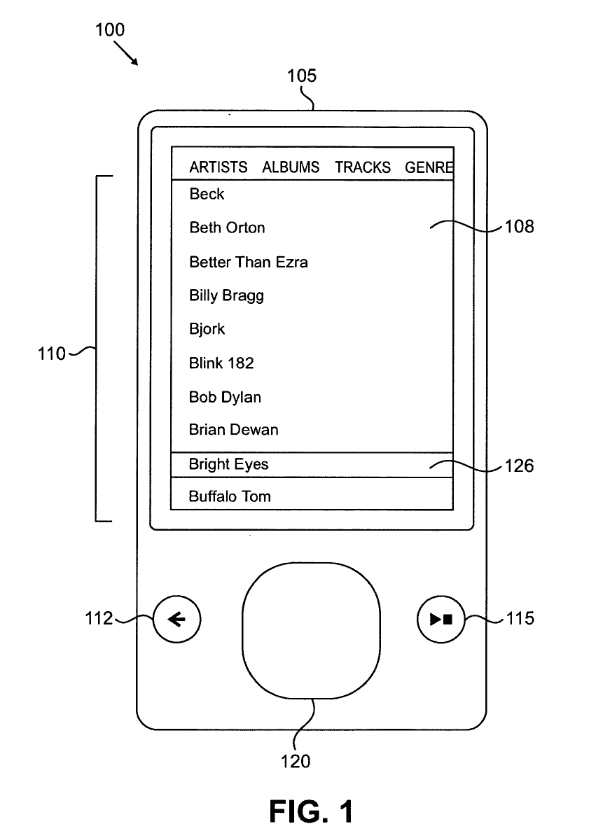

FIG. 1 shows an illustrative environment 100 including a computing device such as a portable media player 105 in which the present user interface (“UI”) employing gestural control may be implemented. The portable media player is configured to render media including music, video, images, text, photographs, etc. in response to end-user input to a UI. The user interface utilizes a display device for showing menus and listing stored content, for example, as well as input devices or controls through which the end-user may interact with the UI. In this example, the portable media player 105 includes a display screen 108 and several user controls including buttons 112 and 115, and a touch or gesture pad (called a “GPad”) 120 that operates as a multi-function control and input device. As the buttons 112 and 115 are placed on either side of the Gpad 120, they are referred to here as side buttons. Buttons 112 and 115 in this illustrative example function conventionally as “back” and “play/pause” controls. The Gpad 120 provides the conventional 5 way D-pad (up/down/left/right/OK (i.e., “enter”) functionality as well as supporting UI gestures as described in more detail below.

The display screen 108 shows, in this example, a UI that includes a list 110 of media content stored on the media player 105 (such as music tracks). It is emphasized that while a list 110 is shown, the term “list” can be generalized to mean a list of line items, a grid, or any series of items. The media player 105 is typically configured to display stored content using a variety of organizational methodologies or schemas (e.g., the content is listed by genre, by artist name, by album name, by track name, by playlist, by most popular etc.). In FIG. 1, a list of artists is shown in alphabetical order with one artist being emphasized via a highlight 126. While an end-user may interact with the UI using gestures as described below, input on the GPad 120 can also mimic the up and down button clicks on a conventional D-pad to scroll up and down the list.

In this illustrative UI, the content lists are placed side by side in a pivoting carousel arrangement. Again, while an end-user may interact with the UI using gestures as described below, input on the on the GPad 120 can also mimic the left and right clicks of a conventional D-pad to pivot among different lists in the carousel. While not shown in the FIG. 1, grids of thumbnails for photographs and other images may be displayed by the media player 105 and accessed in a similar pivoting manner.

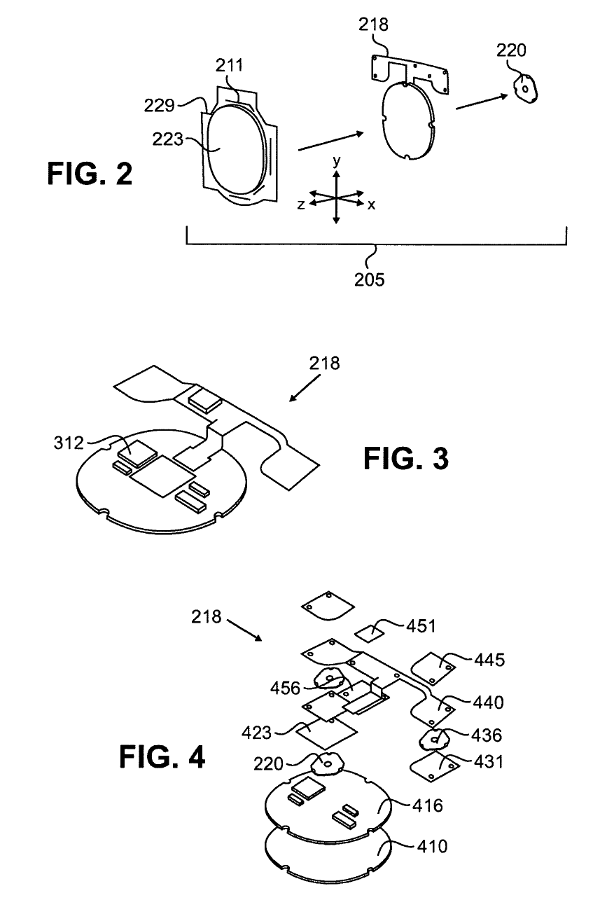

As shown in an exploded assembly view in FIG. 2, GPad 120 comprises a touch sensitive human interface device (“HID”) 205, which includes a touch surface assembly 211 disposed against a sensor array 218, which in this illustrative example, the sensor array 218 is configured as a capacitive touch sensor. In other examples non-capacitive sensor arrays may be employed so that instead of a human appendage, a stylus or other input device may be employed. The sensor array 218 is disposed against a single mechanical switch, which is configured as a snap dome or tact switch 220 in this example. The components shown in FIG. 2 are further assembled into a housing (not shown) that holds the tact switch 220 in place while simultaneously limiting the motion of the touch surface.

The GPad 10 is arranged so when an end-user slides a finger or other appendage across the touch surface assembly 211, the location of the end user's finger relative to a two dimensional plane (called an “X/Y” plane”) is captured by the underlying sensor array 218. The input surface is oriented in such a manner relative to the housing and single switch 221 that the surface can be depressed anywhere across its face to activate (i.e., fire) the switch 220.

By combining the tact switch 220 with the location of the user's touch on the X/Y plane, the functionality of a plurality of discrete buttons, including but not limited to the five buttons used by the conventional D-pad may be simulated even though only one switch is utilized. However, to the end-user this simulation is transparent and the GPad 120 is perceived as providing conventional D-pad functionality.

While the example of the Gpad 10 presented above uses a single switch, in other implementations multiple switches may be employed. The multiple switches may be arranged, for instance, either in a grid or in a traditional d-pad arrangement.

The touch surface assembly 211 includes a touchpad 223 formed from a polymer material that may be arranged to take a variety of different shapes. As shown in FIGS. 1 and 2, the touchpad 223 is shaped as a combination of a square and circle (i.e., substantially a square shape with rounded corners) in plan, and concave dish shape in profile. However, other shapes and profiles may also be used depending upon the requirements of a particular implementation. The touchpad 223 is captured in a flexure spring enclosure 229 which functions to maintain the pad 223 against a spring force. This spring force prevents the touchpad 223 from rattling, as well as providing an additional tactile feedback force against the user's finger (in addition to the spring force provided by the tact switch 220) when the touchpad 223 is pushed in the “z” direction by the user when interacting with the GPad 120. This tactile feedback is received when the user pushes not just the center of the touchpad 223 along the axis where the switch 220 is located, but for pushes anywhere across its surface. The tactile feedback may be supplemented by auditory feedback that is generated by operation of the switch 220 by itself, or be generated through playing of an appropriate sound sample (such as a pre-recorded or synthesized clicking sound) through an internal speaker in the media player or via its audio output port.

The back side of sensor array 218 is shown in FIG. 3 and as an exploded assembly in FIG. 4. As shown in FIG. 4, various components (collectively identified by reference numeral 312) are disposed on the back of the sensor array 218. As shown in FIG. 4, a touch pad adhesive layer is placed on the touchpad 416. An insulator 423 covers the tact switch 220. Side buttons are also implemented using a tact switch 436 which are similarly covered by a side button insulator 431. A flex cable 440 is used to couple the switches to a board to board connector 451. A stiffener 456 is utilized as well as side button adhesive 445, as shown.

The GPad 120 provides a number of advantages over existing input devices in that it allows the end-user to provide gestural, analog inputs and momentary, digital inputs simultaneously, without lifting the input finger, while providing the user with audible and tactile feedback from momentary inputs. In addition, the GPad 120 uses the sensor array 218 to correlate X and Y position with input from a single switch 220. This eliminates the need for multiple switches, located in various x and y locations, to provide a processor in the media player with a user input registered to a position on an X/Y plane. The reduction of the number of switches comprising an input device reduces device cost, as well as requiring less physical space in the device.

In addition to accepting button clicks, the UI supported by the media player 105 accepts gestures from the user. A wide range of different gestures can be utilized. By way of example, the gestures may be single point or multipoint gestures; static or dynamic gestures; continuous or segmented gestures; and/or the like. Single point gestures are those gestures that are performed with a single contact point, e.g., the gesture is performed with a single touch as for example from a single finger, a palm or a stylus. Multipoint gestures are those gestures that can be performed with multiple points, e.g., the gesture is performed with multiple touches as for example from multiple fingers, fingers and palms, a finger and a stylus, multiple styli and/or any combination thereof. Static gestures are those gestures that do not include motion, and dynamic gestures are those gestures that do include motion. Continuous gestures are those gestures that are performed in a single stroke, and segmented gestures are those gestures that are performed in a sequence of distinct steps or strokes. Examples of dynamic gestures include scrub and fling, which will be discussed in more detail below.

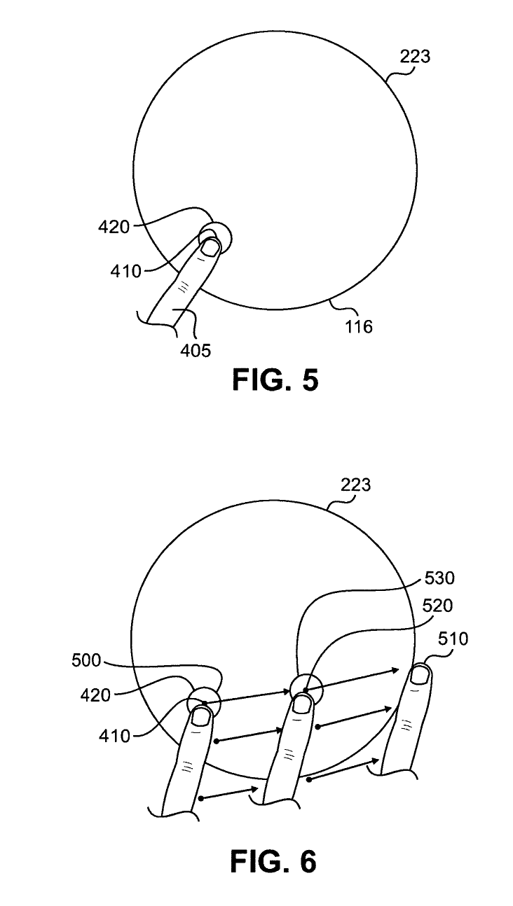

FIG. 5 shows the touchpad 223 of GPad 120. The touchpad 223 may accept an input 405 at a first location 410 on the touchpad 223. The input 405 may be a touch of a finger or from a stylus or any other manner of creating an input 405 on the touchpad 223. A deadzone 420 may be created around the current location 410. The deadzone 420 is a zone surrounding the current location 410. In one embodiment, the zone is of a size such that unintentional shifting on the touchpad 223 is not considered leaving the deadzone 420. The deadzone 420 allows a user to make small input 405 moves without unintentionally activating undesired action. In one embodiment, the size of the deadzone 420 is 50% of the area surrounding the current location 410. Of course, other deadzone 420 sizes are possible. In addition, the size of the deadzone 420 may be adjusted by the user or by applications on the device.

If the input 405 moves outside of the deadzone 420, a location at which the input 405 leaves the deadzone is stored in memory. FIG. 6 may illustrate an example where a user moves a finger (as an input 405) outside the deadzone 420 and the finger left the deadzone 420 at a location 500. Of course, depending on the sensitivity of the touchpad 223, multiple surrounding locations may be possible locations 500 at which the input 405 left the deadzone 420. In one embodiment, the locations 500 may be averaged to find a center or in another embodiment, the first input location 500 received outside the deadzone 420 may be used. Of course, other embodiments are possible.

An input direction (e.g., left-right, right-left, up-down, down-up, diagonal) may be determined by using a direction from a previous location 410 to a current location 520. For example, the current location 520 may the first location and the previous location 410 may be the location at which the input left the deadzone 420. A vector may be created that connects the current location 520 and the previous location 410. This vector may be used to determine if the user desires to execute a particular action such as moving up through a list of items, down through a list of items, or traversing in virtually any direction through a list of items when a variety of directions are enabled. For example, in a two dimensional list where movement is either up or down through a list, the motion across the touchpad 223, which primarily moves left to right but also move a bit upward (such as in FIG. 6) would be interpreted as a desire to move up through the list.

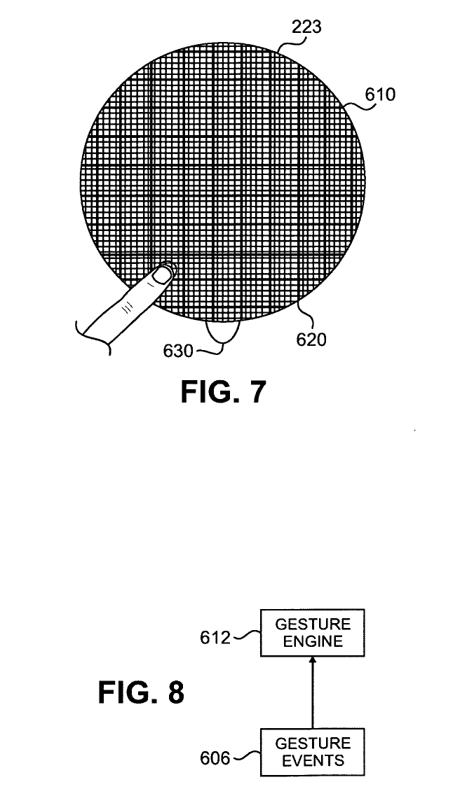

Referring to FIG. 7, horizontal tick lines 610 and vertical tick lines 620 may be created and the direction may be determined by comparing the location of the previous tick lined crossed to the current tick line crossed. If the input 405 moves at least one tick distance, this action may be interpreted as an action to rotate the display of items on the display by a factor that scales with the number of tick distances in the input direction from block 330. In some embodiments, the factor is one, but other factors are possible. The tick distance 630 may be the distance between two horizontal tick lines 610 or two vertical tick lines 620. Of course, the grid could be on different angles and the lines 600 do not have to be perfectly vertical and horizontal. For instance, in one embodiment, the lines 600 are rings around the input 405. In addition, the tick distance 630 may be any distance. The distance may be set by programmers for each application operating on the device. In addition, the tick distance may be related to the size of the input 405 at the first location 410. For example, if a user has large fingers, resulting in a large input 405, the tick distance may be larger than if the input 405 size is small. Of course, the distance between the tick lines may be set in the same manner. In another embodiment, the tick distance 630 is a constant for all applications and all users such that users will develop a feel for the size of movements needed to execute a desire action on the computing device 100.

As shown in FIG. 8, the UI in this example does not directly react to touch data from the GPad 120, but rather to semantic gesture events 606 as determined by a gesture engine 612.

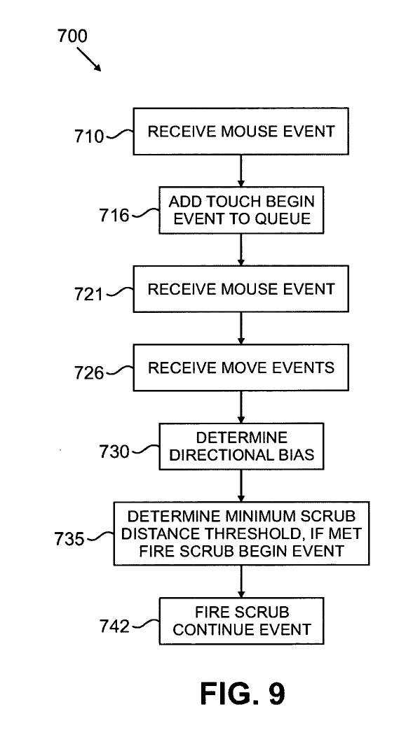

An illustrative scrub behavior is shown in the flowchart 700 shown in FIG. 9. Note that user motions are filtered by a jogger mechanism to produce the gesture events. While this example is described in terms of a Win32 mouse event structure, it should be noted that more generally any message or event structure may be employed, provided it is supported by the UI and the underlying operating system.

At block 710, the gesture engine 612 receives a mouse_event when a user touches the GPad 120:
a. dwFlags—MOUSEEVENTF_ABSOLUTE
b. dx
c. dy
d. dwData—should be zero since we're not processing mouse wheel events
e. dwExtraInfo—one bit for identifying input source (1 if HID is attached, 0 otherwise)

This event translates into a TOUCH BEGIN event that is added to a processing queue as indicated by block 716. At block 721, the gesture engine 612 receives another mouse_event:
a. dwFlags—MOUSEEVENTF_ABSOLUTE
b. dx—absolute position of mouse on X-axis ((0,0) is at upper left corner, (65535, 65535) is the lower right corner)
c. dy—absolute position of mouse on Y-axis (same as X-axis)
d. dwData—0
e. dwExtraInfo—one bit for identifying input source (1 if HID is attached, 0 otherwise)

The gesture is completed when the gesture engine receives a mouse_event when the user releases his finger from the Gpad:
a. dwFlags—MOUSEEVENTF_ABSOLUTE|MOUSEEVENTF_LEFTUP
b. dx—position
c. dy—position
d. dwData—
e. dwExtraInfo—one bit for identifying input source

This event is translated into a TOUC END event.

At block 726, the gesture engine 612 receives eight additional move events which are processed. The initial coordinates are (32000, 4000) which is in the upper middle portion of the touchpad 223, and it is assumed in this example that the user desires to scrub downwards. The subsequent coordinates for the move events are:

1. (32000, 6000)

2. (32000, 8000)

3. (32000, 11000)

4. (32000, 14500)

5. (32000, 18500)

6. (32000, 22000)

7. (32000, 25000)

8. (32000, 26500)

If a scrub occurs, the directional bias needs to be known as indicated at block 730.

Since the distance calculation provides a magnitude, not a direction, the individual delta x and delta y values are tested. The larger delta indicates the directional bias (either vertical or horizontal). If the delta is positive, then a downward (for vertical movement) or a right (for horizontal movement) movement is indicated. If the delta is negative, then an upward or left movement is indicated.

Whether this becomes a scrub depends on whether the minimum scrub distance threshold is crossed as shown at block 735. The distance is calculated using the expression:

\sqrt{(xₙ−xₒ)²+(yₙ−yₒ)²}

Where xₒ and yₒ are the initial touch point, namely (32000, 4000). To avoid a costly square root operation, the minimum scrub distance is a squared and then a comparison is performed.

Assuming the minimum distance threshold for a scrub is 8,000 units, then the boundary will be crossed at coordinate 4, with a y value of 14,500.

Throughout the coordinate grid, there is a concept of jogging tick lines. Each time a tick line is crossed, a Scrub Continue event is fired as shown by block 742. In cases, when a tick is directly landed on, no event is triggered. For vertical jogging, these tick lines are horizontal and a tick size parameter controls their distance from each other. The tick line locations are determined when scrubbing begins; the initial tick line intersects the coordinates where the scrub began. In our example, scrubbing begins at y=12000 so a tick line is placed at y=12000 and N unit intervals above and below that tick line. If N is 3,000, then this scrub would produce additional lines at y=3000, y=6000, y=9000, y=15000, y=18000, y=21000, y=24000, y=27000, y=30000, etc . . . . Thus, by moving vertically downwards, we'd cross tick lines for the following coordinates:

#5 (past y=15000 and past y=18000)

#6 (past y=21000)

#7 (past y=24000)

Note that once a tick line is passed, it cannot trigger another Scrub Continue event until another tick line is crossed or the gesture ends. This is to avoid unintended behavior that can occur due to small back and forth motions across the tick line.

Now, with coordinates 9 and 10:

9. (32000, 28000)

10. (36000, 28500)

In this case, coordinate #9 will trigger another Scrub Continue event. However, for coordinate #10, the user has shifted to the right. No special conditions are needed here—the scrub continues but the jogger does nothing to the input since another tick line has not been crossed. This may seem odd since the user is moving noticeably to the right without continuing downward. However, that does not break the gesture. This is because the jogger keeps scrubs to one dimension.

In summary, a scrub begins when a touch movement passes the minimum distance threshold from the initial touch. The parameters used for gesture detection include the Scrub Distance Threshold which is equivalent to the radius of the “dead zone” noted above. Scrub motion is detected as an end-user's movement passes jogger tick lines. Recall that when a jogger tick line is crossed, it's turned off until another tick line is crossed or the scrub ends. The parameters for gesture detection here are Tick Widths (both horizontal and vertical). The UI physics engine will consider the number of list items moved per scrub event, specifically Scrub Begin and Scrub Continue Events. A scrub is completed when an end-user lifts his or her finger from the touchpad 223.

A fling begins as a scrub but ends with the user rapidly lifting his finger off the Gpad. Because the fling starts as a scrub, we still expect to produce a Scrub Begin event. Afterwards, the gesture engine may produce 0 or more Scrub Continue events, depending on the user's finger's motion. The key difference is that instead of just a Scrub End event, we'd first report a Fling event.

The criteria for triggering a Fling event are twofold. First, the user's liftoff velocity (i.e., the user's velocity when he releases his finger from the GPad 120) must exceed a particular threshold. For example, one could maintain a queue of the five most recent touch coordinates/timestamps. The liftoff velocity would be obtained using the head and tail entries in the queue (presumably, the head entry is the last coordinate before the end-user released his or her finger). It should be noted that the threshold velocity needed to trigger a Fling is generally not set by the gesture engine. Rather, it is determined by each application's user interface.

The second requirement is that the fling motion occurs within a predefined arc. To determine this, separate angle range parameters for horizontal and vertical flings will be available. Note that these angles are relative to the initial touch point; they are not based on the center of the GPad 120. To actually perform the comparison, the slope of the head and tail elements in the recent touch coordinates queue is calculated and compared to the slopes of the angle ranges.

Other types of gestures may be determined in a similar manner to that described above in connection with a scrub and fling. As in the case of a scrub and fling, each type of gesture is triggered by its own set of criteria. In the case of a scrub, for instance, the criterion that must be met is that the input (e.g., input 405) crosses at least one tick line on the touch pad. In the case of fling, the criteria are that (1) the input crosses at least tick line on the touch pad and (2) the liftoff velocity exceeds a particular threshold and (3) the input occur within a predefined arc.

One problem that may arise from the use of gesture control occurs when there are multiple gestures that may be invoked at any one time. This can be a particularly serious problem once the computing device is already in use. For instance, if the computing device is a media player that is in the process of rendering media content, the user could use one of the predefined gestures to unintentionally invoke an action that changes the volume or skips from one track, chapter or scene in a content item to another track, chapter or scene in the content item.

One way to overcome this problem is to classify a gesture as a primary gesture or a secondary gesture. A primary (or first) gesture is any gesture that is involved in performing an action that initiates operation of the device. Such actions include, for instance, actions that turn on the device, actions that present a list of items that may be rendered, and actions that select a particular item for rendering. Secondary (or second) gestures, on the other hand, are those gestures that are generally invoked at some time after a primary gesture has already been invoked. That is, secondary gestures will typically be invoked after the computing device has begun operation. Examples of secondary gestures include those problematic gestures mentioned above that may be unintentionally invoked, such as a gesture that causes a change in volume, for instance.

In order to increase the usability of the UI, it is important that secondary gestures be of a type that can only be invoked intentionally be the user. In addition, the secondary gestures should not be susceptible to being confused with any of the primary gestures. One way to achieve both of these goals is if more criteria are needed to trigger secondary gestures than are needed to trigger primary gestures. In other words, if criteria A and B are required to trigger a particular primary gesture, then a particular secondary gesture may be triggered by criteria A, B and C. By way of example, a scrub may be used for a primary gesture, which, as previously noted is triggered when the input crosses one tick line on the touch pad. A secondary gesture, which may be referred to as a long scrub, may be triggered by the aforementioned criterion needed to trigger a scrub, plus the additional criterion that the input must cross a second tick line on the touch pad without interruption. In other words, a long scrub is triggered when the input crosses two tick lines in a continuous manner.

Instead of simply categorizing gestures into two categories, the gestures more generally may be divided into any number of categories (or subcategories), which could each be invoked by adding additional criteria to each subsequent category

Since a long scrub requires the user to perform more actions than are required to perform a scrub, a long scrub is less likely to be invoked unintentionally. Accordingly, when a scrub is used as a primary gesture a long scrub may advantageously be used as a secondary gesture since it is relatively unlikely to be confused with a scrub. For instance, if a scrub is used as a primary gesture to begin rendering a content item, a long scrub may be used as a secondary gesture to increase or decrease the volume of the content item.

To further reduce the likelihood of unintentionally invoking a secondary gesture, additional criteria may required to trigger it. For instance, instead of simply requiring a long scrub to be triggered when the input crosses two tick lines in a continuous manner, a long scrub may be triggered only when three or more tick lines are crossed in a continuous manner and, further, when the tick lines are crossed within some predetermined period of time (e.g., several milliseconds).

Other variants of a long scrub that may be used execute various actions on the computing device include a long horizontal scrub in which the tick lines that are crossed are horizontal tick lines. Similarly, a long vertical scrub may be triggered when the tick lines that are crossed are vertical tick lines. By way of example, a long horizontal scrub may be used to execute an action on a media device that skips from track, chapter, scene or the like to another track chapter, scene or the like. In this way a user is unlikely to unintentionally cause a skip to occur when he or she, for instance, intended to sort through a list of items, stop the content item currently being rendered or change the content item currently being rendered.

Many other secondary (as well as tertiary, etc.) gestures may be defined that are based on a wide range of multipoint gestures, static gestures, dynamic gestures, continuous gestures, segmented gestures and the like. In each case the secondary gesture can only be triggered when the user input meets a greater number of criteria than the corresponding primary gesture. While it need not always be the case, the criteria used to trigger a particular primary gesture will often be a subset of the criteria needed to trigger a corresponding secondary gesture.

Another problem that may arise from the use of gesture control involves static gestures such as those that are used to simulate a click, okay or enter action on a mouse or the like. Such an action may be used, for example, to select an item from a list that is presented on a display of the computing device. In some cases the active area for this type of static gesture is in the center of the touchpad, although it need not be limited to this location. In any case, the active area may not be visually identified by any marking or the like on the touch pad. Accordingly, the user may not always correctly perform the static gesture within the active area. That is, the user may inadvertently perform a static gesture outside the active area and, as a result, the desired response or action will not be performed.

It has been found that this problem concerning static gestures can be particularly severe if the user attempts to perform the static gesture immediately after the input (e.g., the user's finger or a stylus) has been on the touch pad for a relatively long time or immediately after performing a scrub or other similar gesture. In these cases the user is less likely to lift the input off the touch pad and move it to the active area (e.g., the center of the touchpad). This problem can be reduced in severity if the size of the active area varies in a dynamic manner. For example, the active area may increase in size after the input has been in contact with the touchpad for some predetermined period of time. In this way the user will be more likely to perform the static gesture within the active area. On the other hand, if the input is removed from the touch pad, the active area may return to a smaller size, which may function as a default size. In other words, the active area in which the static gesture may be performed will maintain its default size unless the input has been in contact with the touchpad for some period of time (e.g., 0.750 ms), after which the active area temporarily increases in size. Of course, the size of active area may dynamically vary in other ways as well and is not limited to the two states (e.g., sizes) discussed herein by way of example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of performing an action on a computing device, comprising:
executing a first action in response to receipt of a first user input that is selected from among a first plurality of gestures that are each triggered in accordance with at least one criterion; and
subsequent to executing the first action, executing a second action in response to receipt of a second user input that is selected from among a second plurality of gestures that are each triggered in accordance with one criterion that triggers one of the first plurality of gestures and at least one additional criterion.

2. The method of claim 1 wherein the first plurality of gestures includes a scrub and the criterion that triggers the scrub includes receipt of an input that crosses one tick line on a touch pad.

3. The method of claim 2 wherein the second plurality of gestures includes a long scrub that is triggered by criteria that include receipt of an input that without interruption crosses at least two parallel tick lines on the touch pad.

4. The method of claim 1 wherein the first action displays a list of items and the second action is a change in volume.

5. The method of claim 4 wherein the second plurality of gestures includes a long horizontal scrub that is triggered by criteria that include receipt of an input that without interruption crosses at least two horizontal tick lines on a touch pad.

6. The method of claim 1 wherein the first action displays a list of items to be rendered and the second action is a change from one portion to another portion of a particular item currently being rendered.

7. The method of claim 6 wherein the particular item being rendered is video and the portions of the video are different scenes or segments of the video.

8. The method of claim 3 wherein the criteria that triggers a long scrub further includes crossing the two parallel tick lines within a predetermined period of time.

9. A method for processing a touch input, comprising:
receiving a static gesture at an active area on a touch sensitive input device of a computing device; and
executing an action in response to the static gesture, wherein the active area extends over a defined region on the touch sensitive input device that varies in size in accordance with a state of a touch input that has been received.

10. The method of claim 9 wherein the state of the touch input is a length of time over which the touch input has been received prior to receipt of the static gesture.

11. The method of claim 9 wherein the action performed in response to the static gesture is selection of an item on a display of the computing device.

12. The method of claim 10 wherein the defined region has a default size or a second size greater than the default size, and wherein the active area only extends over the defined region of the second size if the touch input is received for a period of time exceeding a threshold amount of time.

13. The method of claim 10 wherein the defined region has a default size or a second size greater than the default size, and wherein the active area only extends over the defined region of the second size if the touch input is received for a period of time exceeding a threshold amount of time and the touch input and the static gesture are received without any interruption therebetween.

14. The method of claim 12 wherein the defined region returns to the default size after receipt of the static gesture terminates.

15. A method of receiving user inputs for operating a computing device, comprising:
accepting a first gesture as a first user input on an input device of the computing device, wherein the first gesture is triggered when at least N criteria are met, where N is greater than or equal to 1; and
accepting a second gesture as a second user input on the input device, wherein the second gesture is triggered when at least N+1 criteria are met, the N+1 criteria including the N criteria that are needed to trigger the first gesture.

16. The method of claim 15 wherein the first gesture is selected from the group consisting of single point gestures, multipoint gestures, static gestures, dynamic gestures, continuous gestures and segmented gestures.

17. The method of claim 15 wherein the N criteria that trigger the first gesture include receipt of an input that crosses a single tick line on a touch pad.

18. The method of claim 17 wherein an N+1th criteria that is needed to trigger the second gesture includes receipt of an input that without interruption crosses at least two tick lines on the touch pad.

19. The method of claim 18 wherein an N+2^{nd} criteria that is needed to trigger the second gesture further includes receipt of the input that without interruption crosses the two tick lines on the touch pad within a predetermined amount of time.

20. The method of claim 15 wherein the first gesture is a scrub and the second gesture is a long scrub.
